(19) United States
(12) Patent Application Publication
(10) Pub. No.: US 2004/0210454 A1
(43) Pub. Date: Oct. 21, 2004

(54) System and method for providing technology data integration services

(76) Inventors: Bruce M. Coughlin, Medway, MA (US); Raheem A. Hasan, Hanover Park, IL (US); William J. McNamara, Marstons Mills, MA (US); Craig R. Shea, Brockton, MA (US); James U. Jimenez, Marina, CA (US)

Correspondence Address: Siemens Corporation, Intellectual Property Department, 170 Wood Avenue South, Iselin, NJ, 08830, US

(21) Appl. No.: 10/786,913

(22) Filed: Feb. 25, 2004

Related U.S. Application Data
(60) Provisional application No. 60/450,011, filed on Feb. 26, 2003.

(51) Int. Cl. H04N 5/44; G06F 7/00; G06F 17/00; G06N 5/02; G06F 17/60

(52) U.S. Cl. 705/1; 707/104.1; 706/46

(57) ABSTRACT

The management and integration of data and categorizing and reporting the results thereof are accomplished by using at least three information levels of the data path, which comprise a transactions level, an extraction, transformation and load level, and a business information level. At the transformation and load level, data are collected from applications residing at the transactions level and extractions and calculations are performed on the collected data. The results are deposited into a data pool and presented to consumers using components residing at the business information level.

A Computer Program Listing Appendix is included with this application submitted on compact disc (CD), and is hereby incorporated by reference in its entirety and accordingly forms a part of this specification. A duplicate copy of the files are on a copy CD. Both CDs contain the following files:

AppendixA1.txt

AppendixB1.txt

### BACKGROUND OF THE INVENTION

1. Field of the Invention

The present invention generally relates to the management and integration of data and, more particularly, to providing a method and system for integrating data on different aspects of an enterprise and categorizing the results.

2. Description of the Related Art

As the amount, type, and complexity of data related to a typical enterprise's business has grown, it has become more difficult to manage the data. Different types of data call for different databases, and sometimes the same data can be found in different databases related to different technology support applications and is never categorized or correlated in a meaningful way. Duplicative and/or uncorrelated data may make it harder to use the data efficiently to streamline operations and/or control costs. This is especially true in information technology (IT) services, where data related to calls made to a help desk associated with an enterprise's system often stay in a form that makes it difficult to make a quick, accurate assessment of the health of the system. If the data is not processed in an expeditious manner, a problem or inefficiency in the system may go undetected for a lengthy period of time, incurring costs in user productivity, increased calls to the help desk, dispatch of technicians to treat symptoms, etc. Thus, there is a need to implement a system and method to integrate and categorize data quickly, so the health of the system can be tracked in real-time or near real-time, and/or to allow a determination to be made quickly whether a problem needs to be addressed.

### SUMMARY OF THE INVENTION

It is therefore an object of the invention to provide a system and method for providing databases that form relationships between data sets of support applications so that the data may be transformed into a useful form for detecting IT problems and patterns.

It is another object of the invention to provide a system and method for transforming data sets of support applications into a form that allows the efficient assessment of whether action needs to be taken to improve the system on which the data sets reside.

It is yet another object of the invention to provide a system and method for tying together key elements of IT services to provide information readily available for use by the service provider and its customer.

It is yet another object of the invention to provide a system and method for integrating information from human resources, finance, asset, and services systems to deliver a standard, repeatable, and efficient IT service.

It is yet another object of the invention to provide a unique identifier for each system in a network of systems to limit the amount of data integrated to only those key elements required in performing further calculations for the creation of standard tables that contain information to be used to monitor and measure the integrated service being provided.

It is yet another object of the invention to collect, extract, and calculate data from applications to provide a set of reports expressing levels of service achieved during a defined period, key performance indicators, and transaction volumes.

The present invention takes data from different systems and integrates the data into several key databases. Data elements from multiple systems are matched using a unique identifier present in each system. The unique identifier tags allow the amount of data processed to be limited to only the key elements required in performing calculations for the creation of standard tables that contain information to be used to monitor and measure integrated services being provided.

Information is passed from the host systems to data warehouses after calculations are made. At least some of the information may be related to incidents reported to a service desk. The calculations are based on key element attributes which, in a preferred embodiment, are used to deliver repeatable and standard services. Examples of attributes are Contractual SLA Attainment, key performance indicators (KPI) to ensure efficiency, Customer Satisfaction, Continuous Improvement and Cost Reductions. In a preferred embodiment, all the systems are linked via standard data exchange in real time or near real time. The resulting data may be presented in a predefined format, such as reports, using business information from the bottom up. In a preferred embodiment, anyone accessing the data (whether the data relates to, by way of example only, employee productivity, customer satisfaction, or continuous improvement) uses the same process to access and retrieve the data. The reports may be integrated into continuous improvement programs. An example of a technology that can take advantage of the method and system is the SIEQUENCE™ solution available from Siemens Business Services, Inc., having headquarters in Norwalk, Conn.

### BRIEF DESCRIPTION OF THE DRAWING

FIG. 1 is a diagram of a preferred embodiment of a computer network on which the invention may be implemented.

FIG. 2 is a diagram of a preferred embodiment of an information path being used, for an example of the invention.

### DETAILED DESCRIPTION OF A PREFERRED EMBODIMENT

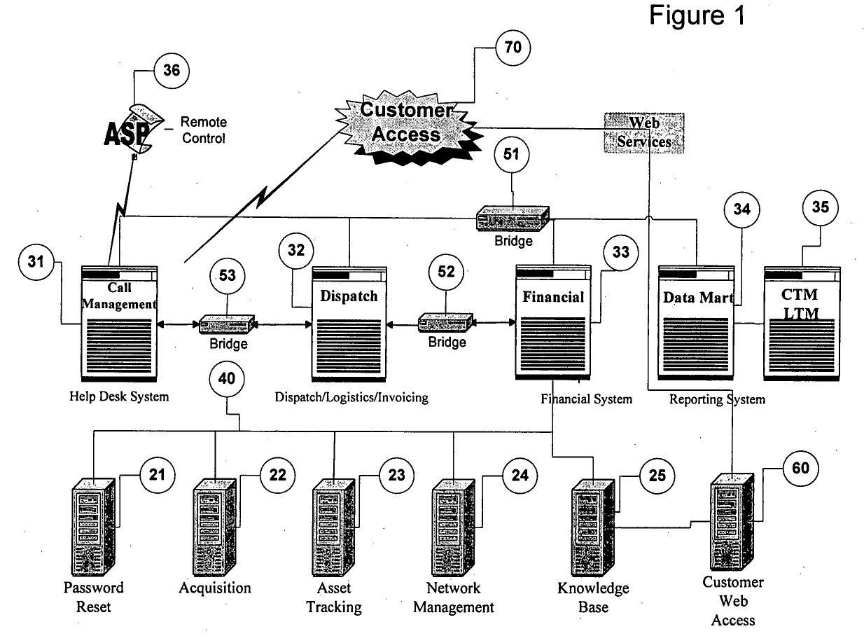

With reference to FIG. 1, a computer network is shown. Technology applications 21, 22, 23, 24, 25 are shown. These technology applications 21, 22, 23, 24, 25 are sometimes referred to as tools and, in a preferred embodiment, they reside on different servers. In the preferred embodiment shown, technology application 21 is used to store and reset passwords, technology application 22 used to process acquisition data (e.g., data pertaining to lifecycle management of hardware infrastructure, such as Purchase, Use/Maintain, Replace), technology application 23 is used for asset tracking, technology application 24 is used for network management, and technology application 25 is used to process knowledge bases (e.g., a repository of knowledge cases organized in support of a business function, such as the help desk, containing a pre-defined domain of business knowledge with a web-based question and answer interface).

Also shown are industry applications 31, 32, 33 which are associated with their own databases. In a preferred embodiment, each of industry application 31, 32, 33 and its associated database reside on its own server. In the preferred embodiment shown, industry application 31 is a call management system (also known as customer relationship management system, or CRM, or help desk system) associated with a service desk (e.g., a help desk), industry application 32 is a dispatch/logistics/invoicing application, and industry application 33 is a financial application. In a preferred embodiment, each one of technology applications 21, 22, 23, 24, 25 is connected to each one of industry applications 31, 32, 33. In a preferred embodiment, these connections are made via bus 40, and in an alternative preferred embodiment each technology application 21, 22, 23, 24, 25 has a separate connection to the industry applications 31, 32, 33. In a preferred embodiment, technology applications 21, 22, 23, 24, 25 and industry applications 31 and 32 are remotely connected to a help desk staff 36. Technology applications 21, 22, 23, 24, 25 and industry applications 31, 32, 33 may be referred to as host systems.

Industry applications 31, 32, 33 are linked to each other by way of bidirectional bridges 51, 52, 53. In a preferred embodiment, each of bridge 51, 52, 53 is a server that allows data residing on different industry applications to be mapped or tied together in data warehouse (also called data mart) 34. For example, in the preferred embodiment shown bridge 52 ties data residing in the database associated with industry application 32 and data residing in the database associated with industry application 33 into data warehouse 34. Since each technology application 21, 22, 23, 24, 25 and industry application 31, 32, 33 has, in a preferred embodiment, its own unique identifier, data from one system can be tied to data in another system. The unique identifier may also be used to relate different data associated with one customer.

Optionally, data warehouse 35, associated with a scheduling and management database, may be used to additionally process data. In a preferred embodiment, data warehouse 35 is linked to data warehouse 34.

Customer access web 60, which in a preferred embodiment resides on its own server, may be used by a customer to review reports and other information associated with technology applications 21, 22, 23, 24, 25, industry applications 31, 32, 33, and data warehouse 34. In a preferred embodiment, a customer at customer access location 70 may access customer access web 60 and industry application 31 remotely.

The following is a description of an example of the implementation of a method in accordance with a preferred embodiment of the invention. A customer has an arrangement (e.g. a contract) for its system to be monitored and/or serviced by a service desk. Industry application 31 categorizes data in its associated database according to types of service desk incidents (e.g. help desk calls) associated with the data. By way of bridge 51, data warehouse 34 obtains this categorized data and further categorizes it using information from technology applications 23 and 24. A script associated with data warehouse 34 posts the newly categorized data to customer access web 60. The customer and/or IT service provider may use this information to determine what course of action to take.

As an example of an application of a preferred embodiment of the invention, a new event, such as the rollout of a new operating system or a new password policy from the security office causes an increase of calls to the help desk. Industry application 31 keeps track of calls to the help desk and creates a new category related to the problem. Data warehouse 34 may pull data from various sources within the network (e.g., industry application 31 and technology application 21 and industry application 33) to determine that this new problem is causing an increase in the dispatches and an increase in costs. By categorizing this data and posting it, data warehouse 34 provides enough information for the customer and/or IT service provider to conclude that it would be cost-effective to immediately start fixing the problem rather than wait for the next regularly scheduled system update. This type of information may be used to generate business information (in the form of reports, dashboards, performance scorecards, etc.) used to continuously improve the monitored/serviced system.

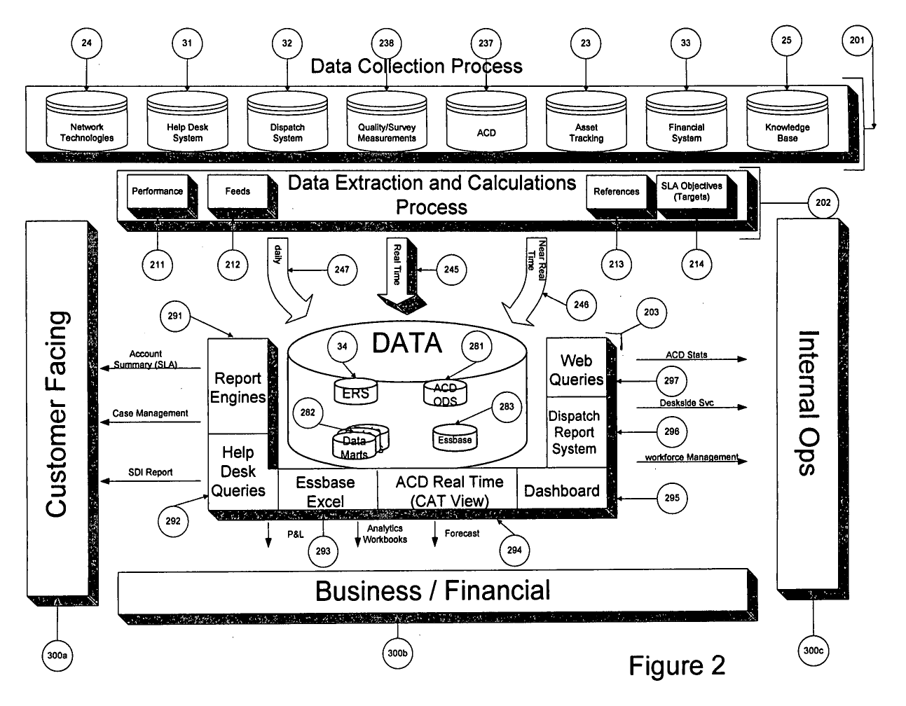

With reference to FIG. 2, a system architecture portraying an example information path utilizing a preferred embodiment of the invention is shown. The levels of the information path in this preferred embodiment is transactions level 201, extraction, transformation & load level 202, and business information level 203.

At extraction, transformation & load level 202 data sets are extracted, (or transformed) and calculated (or processed) on a real time 245, near real time 246, and daily 247 basis, for deposit in data pool 280 (which comprises data warehouse 34, operational data store (ODS) 281, additional data marts 282, and Essbase 283). In the example shown, data is extracted from one or more applications from information level 201 such as technology application 23, technology application 24, technology application 25, industry application 31, industry application 32, industry application 33, technology application 237 (which is used for automatic call distribution to record help desk activity), and technology application 238 (which is an electronic, automated quality/survey measurement, publication, and data system which is interfaced to industry application 31 in a preferred embodiment). Data extraction, transformation & load level 202 comprises performance calculations 211, data feeds 212, references 213, and SLA objectives (also called SLOs or targets) 214.

In a preferred embodiment there is a relationship between the type of data that is collected and calculated and the frequency of these operations. For example, data that is collected, extracted, and calculated on a real time basis 245 comprises data used for operational management and monitoring of a critical business function. In a preferred embodiment, real time data is less than approximately one minute old. By way of another example, data that is collected, extracted, and calculated on a near real time basis 246 comprises data from recently concluded transactions, and can be used to monitor compliance to service objectives during the course of the day. In a preferred embodiment, near real time data is less than approximately one hour old. By way of another example, data that is collected, extracted, and calculated on a daily basis 247 comprises data which can be used to support analysis and reporting (daily and period to date).

The different elements have different roles for providing data that is extracted. For example, technology application 237 captures help desk activity data elements, such as those provided on the CDROM appendix in the file entitled “AppendixA1.txt”; in an automated fashion.

In a preferred embodiment of the invention, another application, industry application 31 also captures help desk activity data elements, such as those provided on the CDROM appendix in the file entitled “AppendixB1.txt.” Most of the data collected by industry application 31 (and kept in a database associated with industry application 31) is automated by reference or lookup table, but certain fields may be reserved for use by individual accounts. For example, customer-centric and/or operations desk-centric business rules can be applied to the use and validation of the following example fields:

Customer Reference 1

Customer Reference 2

Resolution codes

Service Request Catalog (SRC)

Entitlement—A self-describing data set held in a table with 2 fields representing custom labels and values to support a wide variety of data types and values.

The CRM application may also, in a preferred embodiment, have reference tables to provide additional data with respect to the cases (records) in the CRM database:

Business calendars (including coverage hours and holiday schedules)

Sites or Locations

Disposition codes (typically custom combinations of work types and workgroups)

Whether the activity of extraction, transformation & load level 202 takes place on a real time basis 245, near real time basis 246, or daily basis 247, the following three steps or processes generally apply in examples of preferred embodiments of the invention:

First, raw data is loaded into data warehouse 34 or ODS 281. Second, standard performance calculations 211 are applied and the results are stored in data warehouse 34. Third, business rules are applied to assign target objectives to individual cases and/or group cases and/or automatic call distribution (ACD) calls and these results are also stored in data warehouse 34. These three steps or processes are described in greater detail below.

Loading of raw data: Common data warehousing methodologies, such as data denormalization and optimization for data retrieval, are used to perform basis data validation and denormalization and then use the results to load and/or update appropriate data warehouse 34 or ODS 281 tables. Depending on the particular desired reporting, data mart 282 (a subset of data contained in a department or account level database used for analysis within a functional unit) or dashboard application 295 (which is part of business information level 203), the data are loaded on a real time basis 245, near real time basis 246, or daily basis 247.

Application of standard performance calculations 211 and storage of results: In a preferred embodiment, custom business rules are used to govern the calculations of the following set of metrics:

Elapsed Time from Creation to First Activity, Adjusted for Delays and Business Calendar

Elapsed Time from Creation to Dispatch, Adjusted for Delays and Business Calendar

Elapsed Time from Creation to Resolution, Adjusted for Delays and Business Calendar

Elapsed Time from Dispatch to Phone Response, Adjusted for Delays and Business Calendar

Elapsed Time from Dispatch to Resolution, Adjusted for Delays and Business Calendar

Elapsed Time from Creation to First Activity

Elapsed Time from Creation to Dispatch

Elapsed Time from Creation to Resolution

Elapsed Time from Dispatch to Phone Response

Elapsed Time from Dispatch to Resolution

Elapsed Time from Creation to First Activity, Adjusted for Delays

Elapsed Time from Creation to Dispatch, Adjusted for Delays

Elapsed Time from Creation to Resolution, Adjusted for Delays

Elapsed Time from Dispatch to Phone Response, Adjusted for Delays

Elapsed Time from Dispatch to Resolution, Adjusted for Delays

Elapsed Time from Creation to First Activity, Adjusted for Business Calendar

Elapsed Time from Creation to Dispatch, Adjusted for Business Calendar

Elapsed Time from Creation to Resolution, Adjusted for Business Calendar

Elapsed Time from Dispatch to Phone Response, Adjusted for Business Calendar

Elapsed Time from Dispatch to Resolution, Adjusted for Business Calendar

Total Delay Time

Total User-based Delay Time

Total Customer-based Delay Time

Total Parts-based/Vendor-based Delay Time

Total Interim-solution Delay Time

Resolved @ the Help Desk (True/False)

In a preferred embodiment, a business calendar is used to enable the calculation of working hours by keeping track of the following using one-minute intervals:

Account (Customer)

Site

Site Type

Work Type

Service Request Catalog (SRC)

Custom Calendar

Delays may be expressed as time elapsed during normal business hours during the existence of a delay condition. A delay begins at the time posted in the labor time log that contains a Delay code, and ends at the time reported against a non-delay labor type.

In a preferred embodiment, the following KPIs are derived from the ACD data on ODS 281:

Average Queue Time

Number of calls within queue time intervals

Percentage of calls within queue time intervals (telephone service factor)

Number of calls handled

Average Talk Time

Number of abandoned calls

Number of calls abandoned before target abandon queue time

Abandoned calls as percentage of calls offered

Abandoned Calls as Percentage of Calls Handled

Abandoned Calls as Percentage of calls (offered—abandoned before target)

Application of business rules storage of results: Objectives are determined for each service delivered based on a statement of work (SOW). Within each service area (e.g., help desk, network, deskside), the conditions in the SOW are translated into a tailored business process for classifying and resolving a problem call. Data from various applications, e.g. technology application 31 and industry application 237, are used to categorize service events into discrete SLOs 214. The SLOs 214 apply customer-centric and/or operations desk-centric business rules to data captured from each relevant application assign each incident, event, and/or problem ticket to a particular SLO definition. In this example, the SLOs 214 contain the information needed to concretely express the performance objectives of a particular activity. This example uses the following classification examples:

Help Desk

Account

Site (Location)

Site Type (Campus, Metro, Remote)

Severity

Class (Service Request Catalog)

Type (SRC)

Object (SRC)

Product (SRC)

Version (SRC)

Workgroup

Business Unit

Hours of Coverage (Business Calendar)

Automated Call Distribution (ACD) DNIS (800 # dialed)

ACD Agent Group

ACD Application

ACD Option

An SLO 214 in this example may be defined using any combination of values for the above dimensions, and has at least one discrete objective for any of the defined performance metrics.

References 213 in a preferred embodiment are satellite tables in a star-schema database configuration. They can contain any referential data related to the content of the central table in the star schema.

Data feeds 212 in a preferred embodiment are automated mechanisms for moving data between systems, such as moving data between industry application 31 and data warehouse 34, by way of example. Such mechanisms vary and may depend on factors such as, by way of example, source and destination database brands and types (e.g., relational, unstructured, etc.), network connections (e.g., WAN, LAN, Internet, with firewall, without firewall, etc.). A variety of tools may be used to create, deploy, and maintain data feeds 212. For example, in a preferred embodiment a variety of feed mechanisms, such as SQL Server Replication, Publish/Subscribe data containers, Pl SQL programming language, etc., may be employed. In a preferred embodiment feed mechanisms are periodically updated as conditions and requirements change.

The following is a more detailed explanation of the components of the preferred embodiment of business information level 203 shown in FIG. 2. Report engine 291 is a system that generates static reports and posts them to a web site. Clarify Queries 292 are used by operational groups to view the status of cases, in real time, based on industry application 31. The online analytical processing (OLAP) tool 293 is an interface to an OLAP database 283 supporting analysis using multi-dimensional data cubes. Catview 294 is a real-time help desk phone system monitoring tool to alert supervisors to the possibility of a breach of SLA. Dashboard 295 is a visual representation, preferably a set of gauges, that reports on the operational status of a business. SA Report System 296 is a reporting functionality that comes with the dispatch system (Service Access). Web Queries 297 is a set of pre-defined queries performed against the data warehouse 34. These components of business information level 203 comprise applications that provide different ways of presenting the business information to consumers of information.

Examples of consumers of information are Customer Facing 300a (external consumer, for example a customer departmental manager, relationship manager, other operations manager, etc.), Business/Financial 300b (internal consumers of business activity reports) and Internal Ops 300c (operational line management teams such as help desk supervisors and managers).

While the invention has been described in terms of preferred embodiments, those skilled in the art will recognize that the invention can be practiced with modification within the spirit and scope of the appended claims.

We claim:

1. A method of reporting data related to an event comprising the steps of:
matching data elements from multiple systems, wherein each of said multiple systems has a unique identifier;
categorizing said matched data elements to create standard tables that contain information to be used to monitor and measure provided integrated services; and
generating a report from said standard tables.

2. A method of reporting data related to information technology services, comprising the steps of:
categorizing incidents reported to a service desk;
using a bridge to map data related to said categorized incidents and financial information;
utilizing said mapped data to further categorize and resolve said incidents;
generating reports based on data related to said categorized and/or resolved incidents; and
integrating said reports into continuous improvement programs.

3. The method of reporting data of claim 2, wherein said reports provide information associated with the costs of fixing a problem related to at least a subset of said reported incidents.

4. A method of reporting comprising the steps of:
collecting data from at least one application residing at a transactions level;
extracting and performing calculations on said collected data;
depositing the results of said extracting and performing calculations into a data pool; and
presenting information in said data pool to consumers by utilizing at least one component residing at a business information level;
wherein said collecting data and said extracting and performing calculations reside at an extraction, transformation and load level.

5. The method of reporting of claim 4, wherein said collecting data and said extracting and performing calculations is performed on a real time basis.

6. The method of reporting of claim 4, wherein said collecting data and said extracting and performing calculations is performed on a near real time basis.

7. The method of reporting of claim 4, wherein said collecting data and said extracting and performing calculations is performed on a daily basis.

8. The method of reporting of claim 4, wherein said at least one component is a dashboard.

9. The method of reporting of claim 4, wherein said presenting information in said data pool to consumers comprises presenting information in said data pool to at least one of external consumers, internal consumers of business activity reports, or operational line management teams.

10. A method of assigning target objectives comprising the steps of:
loading raw data into at least one of data warehouse or operational data store;
applying standard performance calculations on said raw data residing in said at least one of data warehouse or operational data store and storing results of said standard performance calculations; and
applying business rules to said stored results in order to assign said target objectives.

11. The method of assigning target objectives of claim 10, wherein said applying standard performance calculations is performed on a real time basis.

12. The method of assigning target objectives of claim 10, wherein said applying standard performance calculations is performed on a near real time basis.

13. The method of assigning target objectives of claim 10, wherein said applying standard performance calculations is performed on a daily basis.

14. The method of assigning target objectives of claim 10, wherein said target objectives are based on a statement of work.

15. The method of assigning target objectives of claim 10, wherein said loading raw data utilizes data denormalization and optimization.
